(19) United States
(12) Patent Application Publication
(10) Pub. No.: US 2006/0227273 A1
(43) Pub. Date: Oct. 12, 2006

(54) Liquid crystal display apparatus

(75) Inventors: Kyoung-Ju Shin, Yongin-si (KR); Cheol-Woo Park, Suwon-si (KR); Chong-Chul Chai, Seoul (KR)

Correspondence Address: F. CHAU & ASSOCIATES, LLC, 130 WOODBURY ROAD, WOODBURY, NY, 11797, US

(73) Assignee: Samsung Electronics Co., Ltd., Suwon-si (KR)

(21) Appl. No.: 11/196,623

(22) Filed: Aug. 3, 2005

(30) Foreign Application Priority Data
Apr. 6, 2005 (KR) 2005-28625

(51) Int. Cl. G02F 1/1343

(52) U.S. Cl. 349/139

(57) ABSTRACT

In the provided liquid crystal display apparatus, a first switching element receives a first data signal and a second switching element receives a second data signal having a polarity opposite that of the first data signal. A first pixel electrode is electrically connected to the first switching element to receive the first data signal and a second pixel electrode is electrically connected to the second switching element to receive the second data signal. The second pixel electrode faces the first pixel electrode and is electrically insulated from the first pixel electrode. A liquid crystal layer has liquid crystal molecules aligned in response to the first and second data signals applied to the first and second pixel electrodes, respectively. Thus, the liquid crystal display apparatus may prevent afterimages on a screen thereof and a flickering phenomenon.

### CROSS-REFERENCE TO RELATED APPLICATION

This application claims priority to Korean Patent Application No. 2005-28625 filed on Apr. 6, 2005, the contents of which are herein incorporated by reference in its entirety.

### BACKGROUND OF THE INVENTION

1. Field of the Invention

The present invention relates to a liquid crystal display apparatus, and more particularly to a liquid crystal display apparatus capable of improving the display quality thereof.

2. Description of the Related Art

In general, a liquid crystal display apparatus includes a liquid crystal display panel having a screen, a driving circuit that drives the liquid crystal display panel and a light source that provides the liquid crystal display panel with a light. The liquid crystal display panel has a lower substrate, an upper substrate and a liquid crystal layer disposed between the lower and upper substrates.

The lower substrate includes a plurality of pixels formed thereon in a matrix pattern. Each of the pixels has a gate line to which a gate signal is applied, a data line to which a data signal is applied, and a thin film transistor electrically connected to the gate and data lines. Each of the pixels further includes a pixel electrode electrically connected to the thin film transistor. When the thin film transistor is turned on, the data signal is applied to the pixel electrode.

The upper substrate has a common electrode facing the pixel electrode, and the common electrode receives a common voltage. A potential difference (hereinafter, pixel voltage) between the data signal and the common voltage is applied to the liquid crystal layer.

When the pixel voltage applied to the liquid crystal layer stays either positive or negative, the liquid crystal material in the liquid crystal layer is deteriorated. Therefore, in a conventional liquid crystal display apparatus, the polarity of the data signal is inverted periodically with respect to the common voltage, and thus the pixel voltage having the positive polarity and the negative polarity are alternatively applied to the liquid crystal layer.

An ideal common voltage is the average value of the positive polarity pixel voltage and the negative polarity pixel voltage; however, the ideal common voltage is different from the common voltage applied to the common electrode in practice. Therefore, the voltage level of the positive polarity pixel voltage is different from that of the negative polarity pixel voltage, and thus a flickering phenomenon occurs on the screen of the liquid crystal display apparatus. Also, a DC component remains due to distortion of the common voltage such that the liquid crystal is deteriorated, and afterimages are displayed on the screen.

### SUMMARY OF THE INVENTION

A need therefore exists for a liquid crystal display apparatus capable of removing afterimages and the flickering phenomenon.

In one aspect of the present invention a liquid crystal display apparatus includes a first switching element, a second switching element, a first pixel electrode, a second pixel electrode and a liquid crystal layer.

The first switching element receives a first data signal and the second switching element receives a second data signal having a polarity opposite that of the first data signal.

The first pixel electrode is electrically connected to the first switching element to receive the first data signal and the second pixel electrode is electrically connected to the second switching element to receive the second data signal. The second pixel electrode is insulated from the first pixel electrode. The liquid crystal layer has liquid crystal molecules aligned in response to the first and second data signals applied to the first and second pixel electrodes respectively.

In another aspect of the present invention a liquid crystal display apparatus includes an array substrate, a color filter substrate and a liquid crystal layer. The array substrate has a first substrate and an array layer formed on the first substrate, and the color filter substrate has a second substrate facing the first substrate and a color filter layer formed on the second substrate. The liquid crystal layer is disposed between the first and second substrates and has liquid crystal molecules.

The array layer includes a first switching element, a second switching element, a first pixel electrode and a second pixel electrode. The first switching element receives a first data signal and the second switching element receives a second data signal having a polarity opposite to that of the first data signal.

The first pixel electrode is electrically connected to the first switching element to receive the first data signal. The second pixel electrode is electrically connected to the second switching element to receive the second data signal. The liquid crystal molecules are aligned in response to the first and second data signals applied to the first and second pixel electrodes, respectively.

In still another aspect of the present invention a liquid crystal display apparatus includes a first array substrate, a second array substrate and a liquid crystal layer. The first array substrate has a first substrate and a first array layer formed on the first substrate. The second array substrate has a second substrate facing the first substrate and a second array layer formed on the second substrate. The liquid crystal layer is disposed between the first and second substrates and has liquid crystal molecules.

The first array layer includes a first switching element and a first pixel electrode. The first switching element receives a first data signal and the pixel electrode electrically connected to the first switching element receives the first data signal. The second array layer includes a second switching element and a second pixel electrode facing the first pixel electrode. The second switching element receives a second data signal having a polarity opposite to that of the first data signal. The second pixel electrode electrically connected to the second switching element receives the second data signal.

The liquid crystal molecules are aligned in response to the first and second data signals applied to the first and second pixel electrodes, respectively.

According to the above, the first and second data signals having the polarities opposite to each other are applied to the first and second pixel electrodes, and the polarities of the first and second data signals are periodically inverted. Therefore, the liquid crystal display apparatus may prevent afterimages on a screen thereof and a flickering phenomenon.

### BRIEF DESCRIPTION OF THE DRAWINGS

The above and other features of the present invention will become readily apparent by reference to the following detailed description when considered in conjunction with the accompanying drawings wherein:

FIG. 1 is an equivalent circuit diagram of a pixel of a liquid crystal display apparatus according to an exemplary embodiment of the present invention;

FIG. 2 is a schematic view illustrating polarities of a first data signal and a second data signal of FIG. 1;

FIG. 3 shows a waveform diagram of a first data signal and a second data signal of FIG. 1;

FIG. 4 is an equivalent circuit diagram illustrating a pixel of a liquid crystal display apparatus according to another exemplary embodiment of the present invention;

FIG. 5 is an equivalent circuit diagram illustrating a pixel of a liquid crystal display apparatus according to another exemplary embodiment of the present invention;

FIG. 6 shows a cross-sectional view of a pixel of a liquid crystal display apparatus according to another exemplary embodiment of the present invention;

FIG. 7 shows a plan view of an array substrate of FIG. 6;

FIG. 8 shows a cross-sectional view of a pixel of a liquid crystal display apparatus according to another exemplary embodiment of the present invention;

FIG. 9 shows a cross-sectional view of a pixel of a liquid crystal display apparatus according to another exemplary embodiment of the present invention;

FIG. 10A shows a plan view of a first array substrate of FIG. 9;

FIG. 10B shows a plan view of a second array substrate of FIG. 9; and

FIG. 11 shows a plan view of a liquid crystal display panel having the first and second array substrates of FIGS. 10A and 10B.

### DESCRIPTION OF THE EMBODIMENTS

Hereinafter, the present invention will be explained in detail with reference to the accompanying drawings.

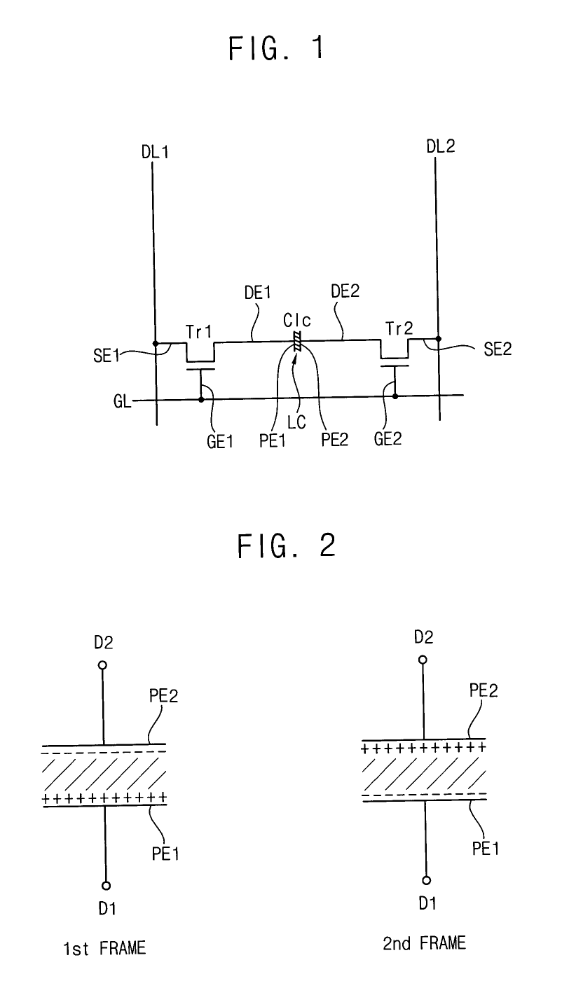

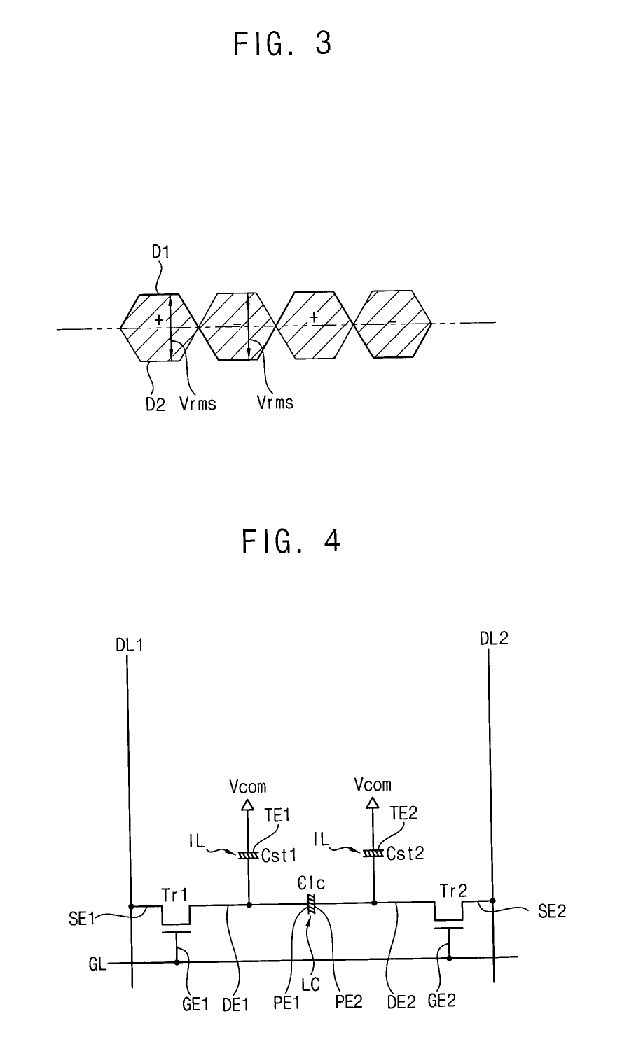

FIG. 1 is an equivalent circuit diagram of a pixel of a liquid crystal display apparatus according to an exemplary embodiment of the present invention. FIG. 2 is a view illustrating polarities of a first data signal and a second data signal of FIG. 1. FIG. 3 shows a waveform diagram of the first and second data signals of FIG. 1.

Referring to FIG. 1, a pixel of a liquid crystal display apparatus according to an exemplary embodiment of the present invention includes a first data line DL1, a second data line DL2, a gate line GL, a first thin film transistor Tr1, a second thin film transistor Tr2 and a liquid crystal capacitor Clc. The liquid crystal capacitor Clc includes a first pixel electrode PE1, a second pixel electrode PE2 and a liquid crystal layer LC.

The first thin film transistor Tr1 includes a first gate electrode GE1 electrically connected to the gate line GL, a first source electrode SE1 electrically connected to the first data line DL1, and a first drain electrode DE1 electrically connected to the first pixel electrode PE1. The second thin film transistor Tr2 includes a second gate electrode GE2 electrically connected to the gate line GL, a second source electrode SE2 electrically connected to the second data line DL2, and a second drain electrode DE2 electrically connected to the second pixel electrode PE2.

The first data line DL1 receives a first data signal, and the second data line DL2 receives a second data signal having a polarity opposite that of the first data signal. The first data signal is applied to the first pixel electrode PE1 via the first thin film transistor Tr1, and the second data signal is applied to the second pixel electrode PE2 via the second thin film transistor Tr2. As shown is in FIGS. 2 and 3, the first data signal D1 having a positive polarity (+) is applied to the first pixel electrode PE1, and the second data signal D2 having a negative polarity (−) is applied to the second pixel electrode PE2 during a first frame. Therefore, a voltage difference (hereinafter, pixel voltage) Vrms between the first data signal D1 and the second data signal D2 has a positive polarity, and the pixel voltage Vrms having the positive polarity is applied to the liquid crystal capacitor Clc during the first frame. The first data signal D1 having a negative polarity (−) is applied to the first pixel electrode PE1, and the second data signal D2 having a positive polarity (+) is applied to the second pixel electrode PE2 during a second frame. Therefore, a pixel voltage Vrms having a negative polarity is applied to the liquid crystal capacitor Clc during the second frame.

The first and second data signals D1 and D2 have polarities different from each other, and the polarities of the first and second data signals D1 and D2 are inverted at every frame. Therefore, the liquid crystal display apparatus may prevent afterimages from being displayed on a screen thereof due to a residual DC component. Also, the pixel voltage Vrms is generated by the first and second data signals D1 and D2. Therefore, the liquid crystal display apparatus may generate the pixel voltage Vrms without a reference voltage, and thus the liquid crystal display apparatus may remove a flickering phenomenon caused by distortion of the reference voltage.

Although not shown in the figures, the polarities of the first and second data signals D1 and D2 applied to the first and second pixel electrodes PE1 and PE2, respectively, may be inverted at every horizontal line.

FIG. 4 is an equivalent circuit diagram illustrating a pixel of a liquid crystal display apparatus according to another exemplary embodiment of the present invention. In FIG. 4, the same reference numerals denote the same elements of FIG. 1.

Referring to FIG. 4, a pixel of a liquid crystal display apparatus according to another exemplary embodiment of the present invention includes the first data line DL1, the second data line DL2, the gate line GL, the first thin film transistor Tr1, the second thin film transistor Tr2, the liquid crystal capacitor Clc, a first storage capacitor Cst1 and a second storage capacitor Cst2.

The liquid crystal capacitor Clc includes the first pixel electrode PE1, the second pixel electrode PE2 and the liquid crystal layer LC. The first storage capacitor Cst1 includes the first pixel electrode PE1, a first storage electrode TE1 and an insulating layer IL, and the second storage capacitor Cst2 includes the second pixel electrode PE2, a second storage electrode TE2 and the insulating layer IL.

The first source electrode SE1 and the first gate electrode GE1 of the first thin film transistor Tr1 are electrically connected to the first data line DL1 and the gate line GL, respectively. The first drain electrode DE1 of the first thin film transistor Tr1 is electrically connected to the first pixel electrode PE1. The second source electrode SE2 and the second gate electrode GE2 of the second thin film transistor Tr2 are electrically connected to the second data line DL2 and the gate line GL, respectively. The second drain electrode DE2 of the second thin film transistor Tr2 is electrically connected to the second pixel electrode PE2.

The first and second storage electrodes TE1 and TE2 receive a common voltage Vcom. Therefore, a voltage difference (hereinafter, first storage voltage) between the first data signal and the common voltage Vcom is applied to the first storage capacitor Cst1, and another voltage difference (hereinafter, second storage voltage) between the second data signal and the common voltage Vcom is applied to the second storage capacitor Cst2. As described above, the first and second storage capacitors Cst1 and Cst2 are connected in parallel to the liquid crystal capacitor Clc. Therefore, a kickback voltage may be reduced, thereby improving the display quality of the liquid crystal display apparatus.

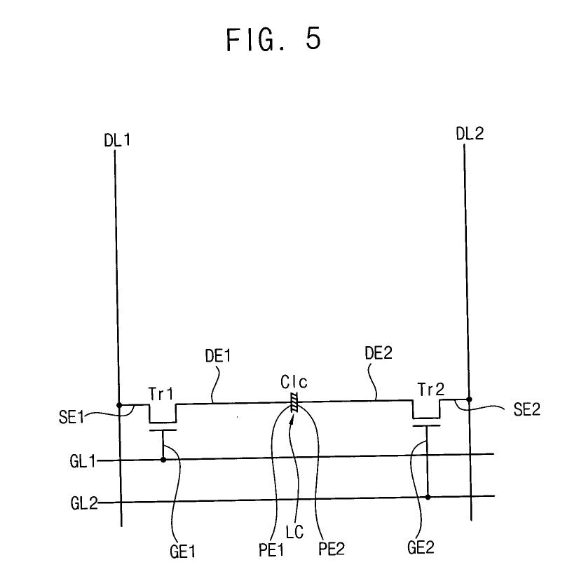

FIG. 5 is an equivalent circuit diagram illustrating a pixel of a liquid crystal display apparatus according to another exemplary embodiment of the present invention. In FIG. 5, the same reference numerals denote the same elements of FIG. 1.

Referring to FIG. 5, a pixel of a liquid crystal display apparatus according to another exemplary embodiment of the present invention includes the first data line DL1, the second data line DL2, a first gate line GL1, a second gate line GL2, the first thin film transistor Tr1, the second thin film transistor Tr2 and the liquid crystal capacitor Clc.

The first thin film transistor Tr1 includes the first source electrode SE1 electrically connected to the first data line DL1, the first gate electrode GE1 electrically connected to a first gate line GL1, and the first drain electrode DE1 electrically connected to the first pixel electrode PE1. The second thin film transistor Tr2 includes the second source electrode SE2 electrically connected to the second data line DL2, the second gate electrode GE2 electrically connected to a second gate line GL2, and the second drain electrode DE2 electrically connected to the second pixel electrode PE2.

The first and second data lines DL1 and DL2 receive first and second data signals, respectively, and the first and second gate lines GL1 and GL2 receive first and second gate signals, respectively. In the present embodiment, the first data signal has a polarity opposite to that of the second data signal. The first and second gate signals have the same voltage level and are substantially simultaneously applied to the first and second gate lines GL1 and GL2, respectively.

When the first and second gate signals are applied to the first and second gate lines GL1 and GL2, respectively, the first thin film transistor Tr1 provides the first pixel electrode PE1 with the first data signal in response to the first gate signal, and the second thin film transistor Tr2 provides the second pixel electrode PE2 with the second data signal in response to the second gate signal. Therefore, an electric field corresponding to a voltage difference between the first and second data signals is formed between the first and second electrodes PE1 and PE2.

As described above, the first and second thin film transistors Tr1 and Tr2 are electrically connected to one gate line GL in FIG. 1. On the other hand, the first and second thin film transistors Tr1 and Tr2 may be electrically connected to the first and second gate lines GL1 and GL2, respectively in FIG. 5.

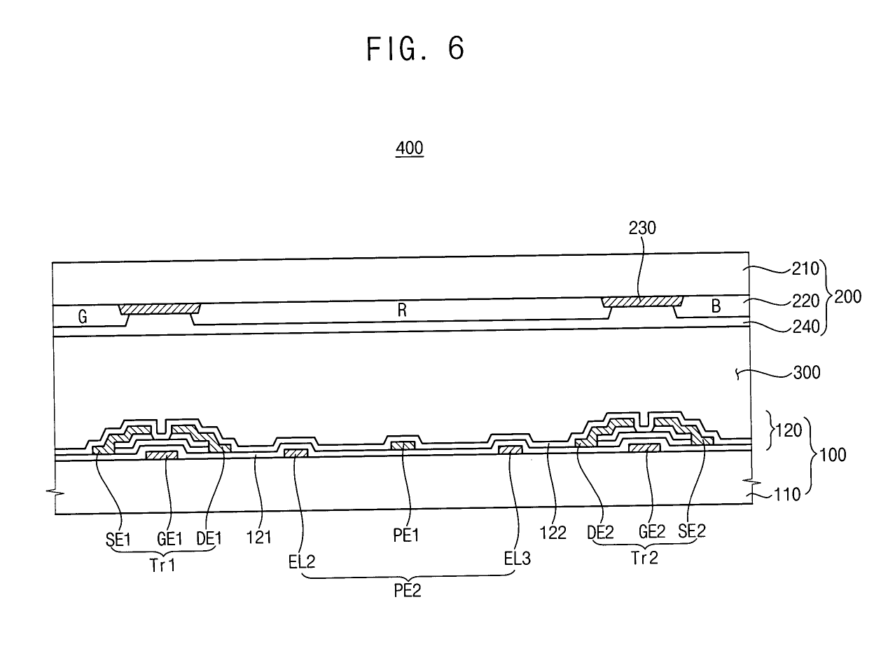

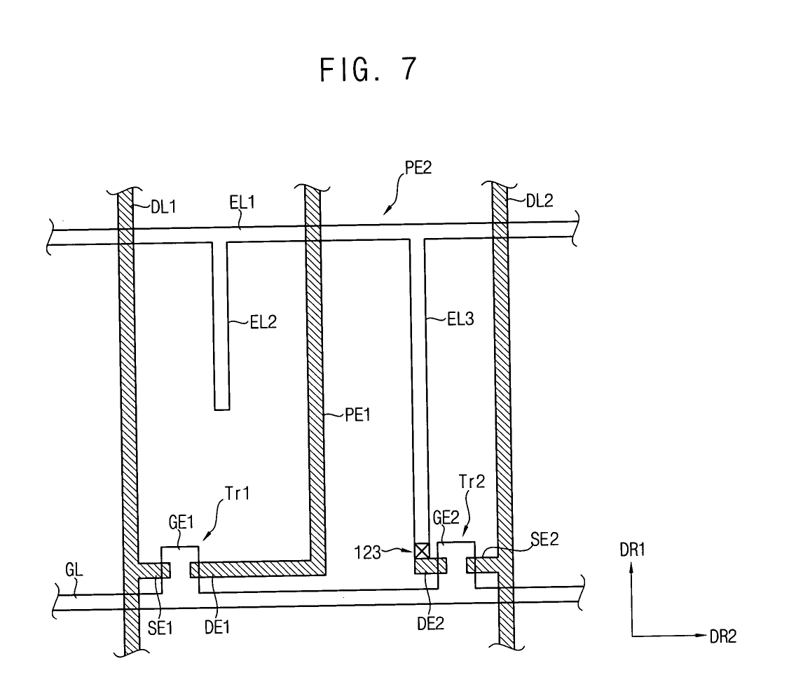

FIG. 6 shows a cross-sectional view of a pixel of a liquid crystal display apparatus according to another exemplary embodiment of the present invention. FIG. 7 shows a plan view of an array substrate of FIG. 6. In FIGS. 6 and 7, a liquid crystal display apparatus operated in a horizontal electric field switching mode will be described.

Referring to FIGS. 6 and 7, a liquid crystal display apparatus 400 includes an array substrate 100, a color filter substrate 200 facing the array substrate 100 and a first liquid crystal layer 300 disposed between the array substrate 100 and the color filter substrate 200.

The array substrate 100 has a first substrate 110 and an array layer 120 disposed on the first substrate 110. The array layer 120 includes the first thin film transistor Tr1, the second thin film transistor Tr2, the first pixel electrode PE1 and the second pixel electrode PE2.

As shown in FIG. 7, the array layer 120 further includes the first data line DL1, the second data line DL2 and the gate line GL. The first and second data lines DL1 and DL2 are extended in a first direction DR1, and the gate line GL is extended in a second direction DR2 substantially perpendicular to the first direction DR1. The first and second data lines DL1 and DL2 receive a first data signal and a second data signal, respectively. In the present embodiment, the first data signal has a polarity opposite to that of the second data signal.

The gate line GL includes a first metal material and is disposed on the first substrate 110. The first and second gate electrodes GE1 and GE2 of the first and second thin film transistors Tr1 and Tr2 are branched from the gate line GL. The second pixel electrode PE2 includes the same material as the gate line GL. The second pixel electrode PE2 includes a first electrode line EL1 extended in the second direction DR2, second and third electrode lines EL2 and EL3 branched from the first electrode line EL1. The second and third electrode lines EL2 and EL3 are extended in the first direction DR1 and spaced apart from each other.

The array layer 120 further includes a first insulating layer 121. The first insulating layer 121 covers the gate line GL, the first and second gate electrodes GE1 and GE2 and the second pixel electrode PE2. The first insulating layer 121 includes silicon oxide (SiOx) or silicon nitride (SiNx).

The first and second data lines DL1 and DL2 include a second metal material and are disposed on the first insulating layer 121. The first and second source electrodes SE1 and SE2 of the first and second thin film transistors Tr1 and Tr2 are branched from the first and second data lines DL1 and DL2, respectively. The first and second drain electrodes DE1 and DE2 of the first and second thin film transistors Tr1 and Tr2 are spaced apart from the first and second source electrodes SE1 and SE2, respectively. The first pixel electrode PE1 including the second metal material is electrically connected to the first drain electrode DE1. Thus, a first data signal output from the first data line DL1 is applied to the first pixel electrode PE1.

In the present embodiment, the first pixel electrode PE1 is bent a predetermined amount while the first pixel electrode PE1 is extended in the first direction DR1. Therefore, the first pixel electrode PE1 is disposed between the second and third electrode lines EL2 and EL3 of the second pixel electrode PE2.

On the other hand, the third electrode line EL3 of the second pixel electrode PE2 is electrically connected to the second drain electrode DE2. Particularly, the first insulating layer 121 has a first contact hole 123 through which the second drain electrode DE2 is exposed, and the third electrode EL3 is electrically connected to the second drain electrode DE2 via the first contact hole 123. Therefore, the second data signal output from the second data line DL2 is applied to the second pixel electrode PE2.

According to another exemplary embodiment of the present invention, the first and second pixel electrodes PE1 and PE2 may include a transparent and conductive material, such as indium tin oxide or indium zinc oxide, etc.

The array layer 120 further includes a second insulating layer 122. The second insulating layer 122 covers the first and second source electrodes SE1 and SE2, the first and second drain electrodes DE1 and DE2 and the first pixel electrode PE1. The second insulating layer 122 includes silicon oxide (SiOx) or silicon nitride (SiNx).

The color filter substrate 200 includes a second substrate 210, a color filter layer 220, a black matrix 230 and an overcoating layer 240. The color filter layer 220 on which red, green and blue color pixels R, G and B are formed is disposed on the second substrate 210. The red, green and blue color pixels R, G and B are spaced apart from each other. The black matrix 230 is disposed between two color pixels adjacent to each other to block light. The overcoating layer 240 is disposed on the color filter layer 220 and the black matrix 230 to planarize a step difference between the color filter layer 220 and the black matrix 230.

The first liquid crystal layer 300 includes nematic liquid crystal molecules. When the first and second data signals are applied to the first and second pixel electrodes PE1 and PE2, respectively, the nematic liquid crystal molecules are turned by the horizontal electric field formed between the first and second pixel electrodes PE1 and PE2. Therefore, the nematic liquid crystal molecules are aligned by the horizontal electric field such that a longitudinal axis of the nematic liquid crystal molecules is substantially parallel with the plane of the first substrate 110. Thus, the liquid crystal display apparatus 400 may control the light transmittance of the nematic liquid crystal molecules, thereby displaying images.

In FIGS. 6 and 7, the liquid crystal display apparatus 400 operated in the horizontal electric field switching mode is disclosed. However, in a liquid crystal display apparatus operated in a fringe electric field switching mode, the first and second data signals having polarities different from each other may be applied to the first and second pixel electrodes PE1 and PE2.

As described above, the polarities of the first and second data signals applied to the first and second pixel electrodes PE1 and PE2, respectively, are inverted at every frame or every line. Therefore, the liquid crystal display apparatus 400 may prevent afterimages on a screen thereof and a flicker phenomenon, thereby improving the display quality of the liquid crystal display apparatus 400.

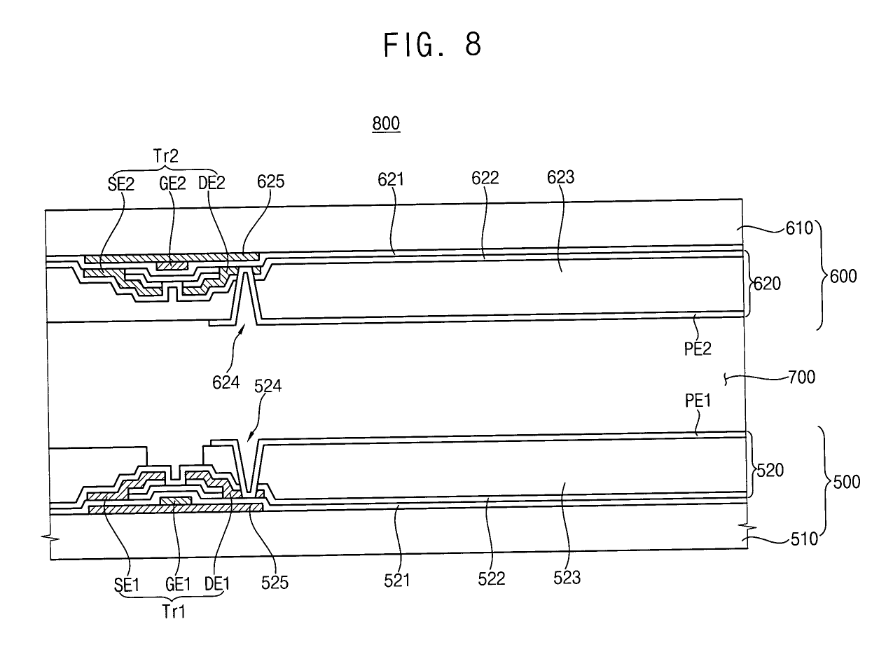

FIG. 8 shows a cross-sectional view of a pixel of a liquid crystal display apparatus according to another exemplary embodiment of the present invention. In FIG. 8, a liquid crystal display apparatus operated in a twisted nematic mode will be described.

Referring to FIG. 8, a liquid crystal display apparatus 800 includes a first array substrate 500, a second array substrate 600 facing the first array substrate 500 and a second liquid crystal layer 700 between the first and second array substrates 500 and 600.

The first array substrate 500 has a first substrate 510 and a first array layer 520 disposed on the first substrate 510. The first array layer 520 includes the first thin film transistor Tr1, the first data line (not shown), the first gate line (not shown) and the first pixel electrode PE1.

The first gate line and a first gate electrode GE1 of the first thin film transistor Tr1 branched from the first gate line are formed on the first substrate 510.

The first array layer 520 further includes a first insulating layer 521 formed over the first substrate 510, so that the first insulating layer 521 covers the first gate line and the first gate electrode GE1.

The first data line, the first source electrode SE1 of the first thin film transistor Tr1 branched from the first data line, and the first drain electrode DE1 of the first thin film transistor Tr1 spaced apart from the first source electrode SE1 are formed on the first insulating layer 521.

The first array layer 520 further includes a second insulating layer 522. The second insulating layer 522 covers the first data line, the first source electrode SE1 and the first drain electrode DE1. A color filter layer 523 on which red, green and blue color pixels are formed is formed on the second insulating layer 522. A second contact hole 524 is formed through the second insulating layer 522 and the color filter layer 523 to partially expose the first drain electrode DE1.

The first pixel electrode PE1 includes a transparent and conductive material and is formed on the color filter layer 523. The first pixel electrode PE1 is electrically connected to the first drain electrode DE1 via the second contact hole 524.

The second array substrate 600 has a second substrate 610 and a second array layer 620 disposed on the second substrate 610. The second array layer 620 includes the second thin film transistor Tr2, the second data line (not shown), the second gate line (not shown) and the second pixel electrode PE2.

The second gate line and the second gate electrode GE2 of the second thin film transistor Tr2 branched from the second gate line are formed on the second substrate 610.

The second array layer 620 further includes a third insulating layer 621 formed over the second substrate to cover the second gate line and the second gate electrode GE2.

The second data line, the second source electrode SE2 of the thin film transistor Tr2 branched from the second data line, and the second drain electrode DE2 of the thin film transistor Tr2 spaced apart from the second source electrode SE2 are formed on the third insulating layer 621.

The second array layer 620 further includes a fourth insulating layer 622 and a first organic insulating layer 623. The fourth insulating layer 622 covers the second data line, the second source electrode SE2 and the second drain electrode DE2, and the first organic insulating layer 623 is formed on the fourth insulating layer 622. A third contact hole 624 is formed through the fourth insulating layer 622 and the first organic insulating layer 623 to partially expose the second drain electrode DE2.

The second pixel electrode PE2 includes a transparent and conductive material and is formed on the first organic insulating layer 623. The second pixel electrode PE2 is electrically connected to the second drain electrode DE2 via the third contact hole 624.

As shown in FIG. 8, the first array layer 520 further includes a first black matrix 525 between the first thin film transistor Tr1 and the first substrate 510, and the second array layer 620 further includes a second black matrix 625 between the second thin film transistor Tr2 and the second substrate 610. The first and second black matrixes 525 and 625 include a metal material to block light. Therefore, the first black matrix 525 absorbs light supplied to the first substrate 510, to prevent the light from being supplied to the second thin film transistor Tr2. The second black matrix 625 absorbs light supplied to the second substrate 610 to prevent the light from being supplied to the first thin film transistor Tr1.

When the first array substrate 500 is coupled to the second array substrate 600, the first pixel electrode PE1 faces the second pixel electrode PE2. The second liquid crystal layer 700 includes twisted nematic liquid crystal molecules and is disposed between the first and second pixel electrodes PE1 and PE2.

When the first gate signal is applied to the first gate line, the first thin film transistor Tr1 provides the first pixel electrode PE1 with a first data signal applied to the first data line. Substantially simultaneously, when the second gate signal is applied to the second gate line, the second thin film transistor Tr2 provides the second pixel electrode PE2 with the second data signal applied to the second data line. In the present embodiment, the second data signal has a polarity opposite to that of the first data signal. Thus, a twisted angle of the twisted nematic liquid crystal molecules is changed by an electric field applied between the first and second pixel electrodes PE1 and PE2. As a result, the liquid crystal display apparatus 800 may control light transmittance of the twisted nematic liquid crystal molecules, thereby displaying the images.

As described above, the polarities of the first and second data signals that are applied to the first and second pixel electrodes PE1 and PE2, respectively, are inverted at every frame or every line. Therefore, the liquid crystal display apparatus 800 may prevent afterimages from being displayed on a screen thereof and a flickering phenomenon, so that the liquid crystal display apparatus 800 may have an improved display quality.

In FIG. 8, the liquid crystal display apparatus 800 operated in the twisted nematic mode is disclosed. However, in a liquid crystal display apparatus operated in a vertical alignment mode or patterned vertical alignment mode, the first and second data signals having polarities different from each other may be applied to the first and second pixel electrodes PE1 and PE2.

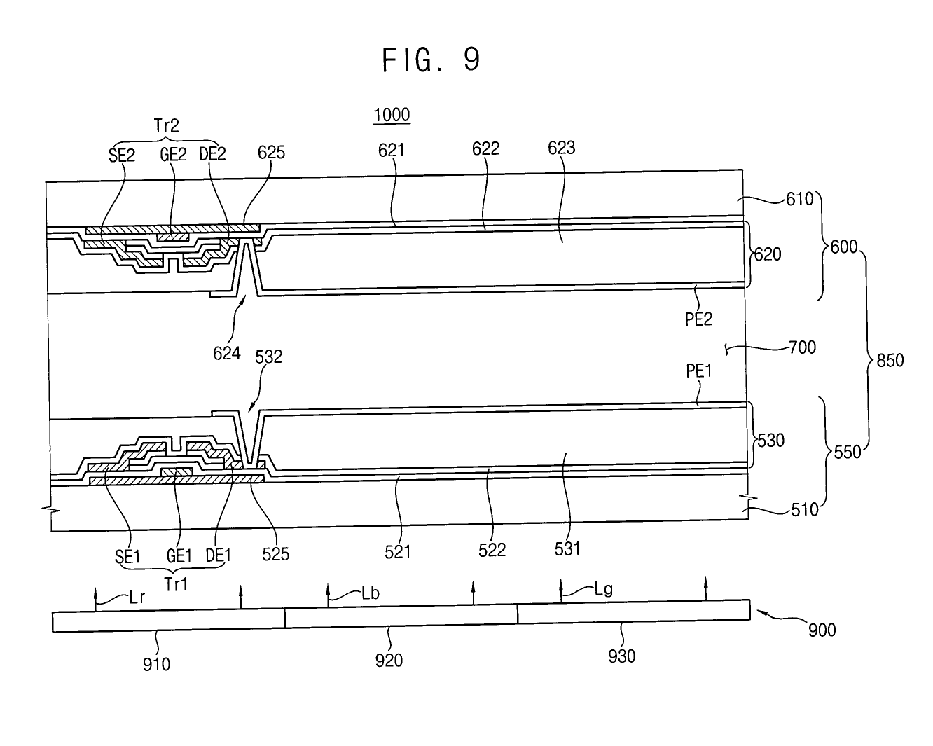

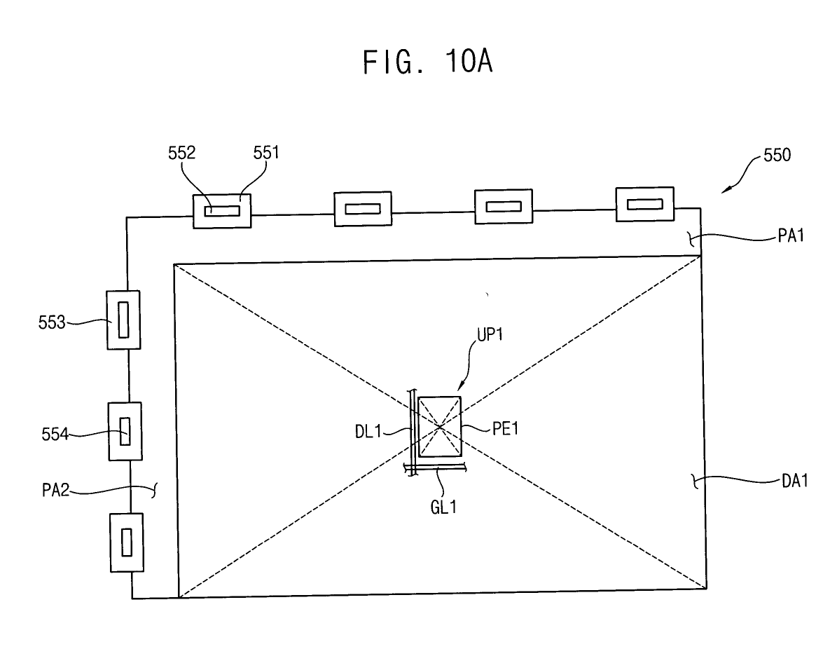

FIG. 9 shows a cross-sectional view of a pixel of a liquid crystal display apparatus according to another exemplary embodiment of the present invention. In FIG. 9, the same reference numerals denote the same elements in FIG. 8.

Referring to FIG. 9, a liquid crystal display apparatus 1000 includes a liquid crystal display panel 850 displaying images using a light and a backlight assembly disposed under the liquid crystal display panel 850 to generate the light. A plurality of pixels is disposed on the liquid crystal display panel 850 in a matrix pattern.

In FIG. 8, the first array substrate 500 has the color filter layer 523. In FIG. 9, a third array substrate 550 has a second organic insulating layer. The second organic insulating layer 531 is disposed between the first pixel electrode PE1 and the third insulating layer 522.

The backlight assembly 900 includes red, green and blue point light sources 910, 920 and 930. The red, green and blue point light sources 910, 920 and 930 are disposed in an area on which a pixel is disposed. The red, green and blue point light sources 910, 920 and 930 sequentially generate red, green and blue lights Lr, Lg and Lb during a horizontal line period (1H), the time for which the pixel is turned on. As a result, the liquid crystal display panel 850 does not require the color filter layer 523 having the red, green and blue color pixels R, G and B.

Therefore, a step forming the color filter layer 523 on the third array substrate 550 may be omitted, thereby simplifying the process of manufacturing the liquid crystal display panel.

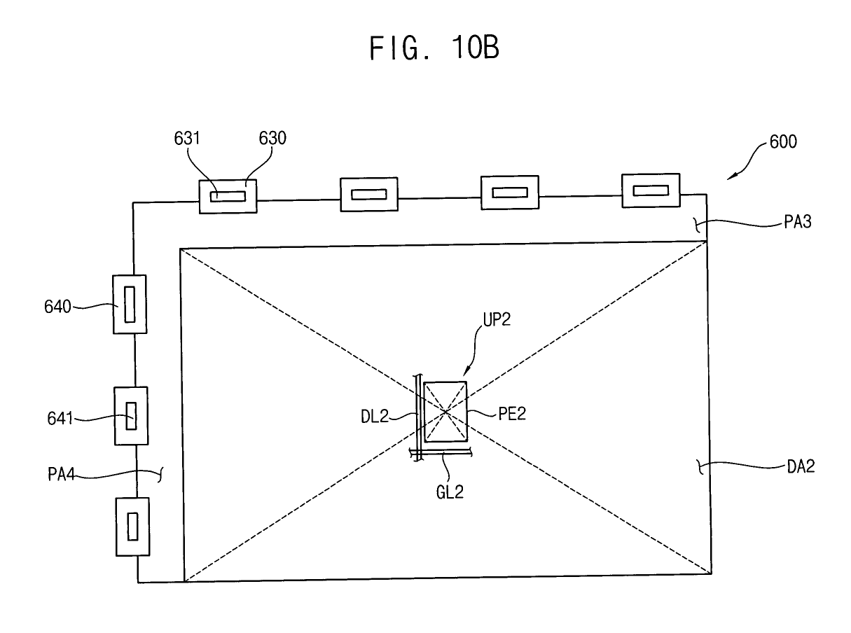

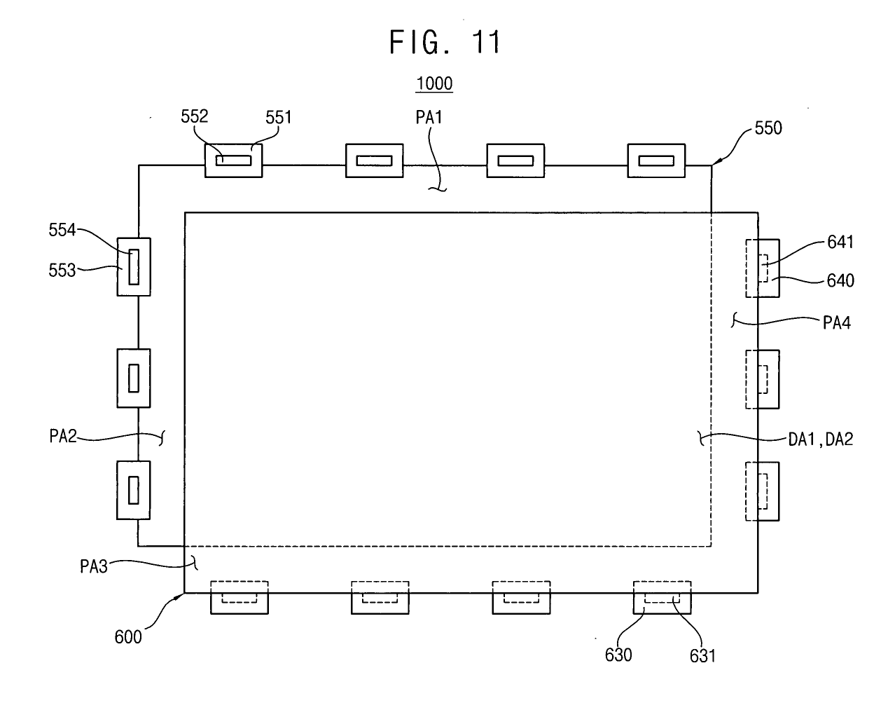

FIG. 10A shows a plan view of a first array substrate of FIG. 9. FIG. 10B shows a plan view of a second array substrate of FIG. 9. FIG. 11 shows a plan view of a liquid crystal display panel having the first and second array substrates of FIGS. 10A and 10B.

Referring to FIG. 10A, the first array substrate 550 is divided into a first display area DA1, a first peripheral area PA1 adjacent to the first display area DA1 and a second peripheral area PA2 adjacent to the first display area DA1. A first pixel UP1 is disposed in the first display area DA1 of the first array substrate 550 and includes the first data line DL1, the first gate line GL1 and the first pixel electrode PE1. Although not shown in FIG. 10A, the first pixel UP1 may further include the first thin film transistor.

A first data tape carrier package 551 is attached to the first array substrate 550 corresponding to the first peripheral area PA1, and a first data driving chip 552 is mounted on the first data tape carrier package 551 to provide the first data line DL1 with the first data signal. A first gate tape carrier package 553 is attached to the first array substrate 550 corresponding is to the second peripheral area PA2, and a first gate driving chip 554 is mounted on the first gate tape carrier package 553 to provide the first gate line GL1 with the first gate signal.

Referring to FIG. 10B, the second array substrate 600 is divided into a second display area DA2, a third peripheral area PA3 adjacent to the second display area DA2 and a fourth peripheral area PA4 adjacent to the second display area DA2. A second pixel UP2 is disposed in the second display area DA2 of the second array substrate 600 and includes the second data line DL2, the second gate line GL2 and the second pixel electrode PE2. Although not shown in FIG. 10B, the second pixel UP2 may further include the second thin film transistor.

A second data tape carrier package 630 is attached to the second array substrate 600 corresponding to the third peripheral area PA3, and a second data driving chip 631 is mounted on the second data tape carrier package 630 to provide the second data line DL2 with the second data signal. A second gate tape carrier package 640 is attached to the second array substrate 600 corresponding to the fourth peripheral area PA4, and a second gate driving chip 641 is mounted on the second gate tape carrier package 640 to provide the second gate line GL2 with the second gate signal.

As shown in FIGS. 10A and 10B, the first pixel UP1 and the second pixel UP2 having the same structure as the first pixel UP1 are disposed on the first and second array substrates 550 and 600, respectively. Therefore, masks used to pattern the first pixel UP1 of the first array substrate 550 may be used to pattern the second pixel UP2 of the second array substrate 600. As described above, since the first and second substrates 550 and 600 may use the same mask, the process of manufacturing the liquid crystal display apparatus 1000 may be simplified, and the manufacturing cost of the liquid crystal display apparatus may be reduced.

Referring to FIG. 11, when the second array substrate 600 is completed, the second array substrate 600 is turned at an angle of about 180 degrees, and the second array substrate 600 is inverted, so that the rear surface and the front surface of the second array substrate are reversed. Then, the second array substrate 600 is coupled to the first array substrate 550. As the second array substrate 600 is coupled to the first array substrate 550, the first display area DA1 of the first array substrate 550 is matched to the second display area DA2 of the second array substrate 600. Therefore, the first pixel UP1 disposed in the first display area DA1 is accurately matched to the second pixel UP2 disposed in the second display area DA2.

On the other hand, the portions of the first array substrate 550 corresponding to the first and second peripheral areas PA1 and PA2 do not face the second array substrate 600. Thus, the first data tape carrier package 551 and the first gate tape carrier package 553 may be attached to the first array substrate 550 corresponding to the first and second peripheral areas PA1 and PA2, respectively.

Also, the portions of the second array substrate 600 corresponding to the third and fourth peripheral areas PA3 and PA4 do not face the first array substrate 550. Thus, the second data tape carrier package 630 and the second gate tape carrier package 640 may be attached to the second array substrate 600 corresponding to the third and fourth peripheral areas PA3 and PA4, respectively.

According to the liquid crystal display apparatus, the first and second data signals having polarities opposite to each other are applied to the first and second pixel electrodes, respectively, and the polarities thereof are inverted at every frame or every line.

Therefore, the pixel voltage is defined by the first and second data signals, and the liquid crystal display apparatus does not need a reference voltage, so that the liquid crystal display apparatus may prevent the flickering phenomenon caused by the distortion of the reference voltage.

Also, the polarities of the first and second data signals are periodically inverted and the residual DC component is removed, thereby preventing afterimages from being displayed on the screen thereof.

Although the exemplary embodiments of the present invention have been described, it is understood that the present invention should not be limited to these exemplary embodiments but various changes and modifications can be made by one of ordinary skill in the art within the spirit and scope of the present invention as hereinafter claimed.

What is claimed is:

1. A liquid crystal display apparatus comprising:
a first switching element to receive a first data signal;
a second switching element to receive a second data signal having a polarity opposite that of the first data signal;
a first pixel electrode electrically connected to the first switching element to receive the first data signal;
a second pixel electrode electrically connected to the second switching element to receive the second data signal, wherein the second pixel electrode is electrically insulated from the first pixel electrode; and
a liquid crystal layer having liquid crystal molecules aligned in response to the first and second data signals applied to the first and second pixel electrodes, respectively.

2. The liquid crystal display apparatus of claim 1, further comprising:
a first data line electrically connected to a first source electrode of the first switching element; and
a second data line electrically connected to a second source electrode of the second switching element.

3. The liquid crystal display apparatus of claim 2, further comprising a gate line commonly electrically connected to a first gate electrode of the first switching element and a second gate electrode of the second switching element to provide the first and second gate electrodes with a gate signal.

4. The liquid crystal display apparatus of claim 2, further comprising:
a first gate line electrically connected to a first gate electrode of the first switching element to provide the first gate electrode with a first gate signal; and
a second gate line electrically connected to a second gate electrode of the second switching element to provide the second gate electrode with a second gate signal.

5. The liquid crystal display apparatus of claim 1, further comprising:
a first storage electrode facing the first pixel electrode, wherein the first storage electrode is electrically insulated from the first pixel electrode; and
a second storage electrode facing the second pixel electrode, wherein the second storage electrode is electrically insulated from the second pixel electrode.

6. A liquid crystal display apparatus comprising:
an array substrate having a first substrate and an array layer on the first substrate,
the array layer comprising:
a first switching element to receive a first data signal,
a second switching element to receive a second data signal having a polarity opposite to that of the first data signal,
a first pixel electrode electrically connected to the first switching element to receive the first data signal, and
a second pixel electrode electrically connected to the second switching element to receive the second data signal;
a color filter substrate having a second substrate facing the first substrate and a color filter layer on the second substrate; and
a liquid crystal layer between the first and second substrates, the liquid crystal layer having liquid crystal molecules aligned in response to the first and second data signals applied to the first and second pixel electrodes, respectively.

7. The liquid crystal display apparatus of claim 6, wherein a first gate electrode of the first switching element, the second pixel electrode and a second gate electrode of the second switching element are comprised of a first metal material and are disposed on the first substrate.

8. The liquid crystal display apparatus of claim 7, wherein the array layer further comprises a gate line commonly electrically connected to the first and second gate electrodes to provide the first and second gate electrodes with a gate signal.

9. The liquid crystal display apparatus of claim 7, wherein the array layer further comprises a first insulating layer to cover the second pixel electrode and the first and second gate electrodes.

10. The liquid crystal display apparatus of claim 9, wherein a first source electrode and a first drain electrode of the first switching element, the first pixel electrode, a second source electrode and a second drain electrode of the second switching element are comprised of a second metal material and are disposed on the first insulating layer.

11. The liquid crystal display apparatus of claim 10, wherein the array layer further comprises:
a first data line electrically connected to the first source electrode to provide the first source electrode with the first data signal; and
a second data line electrically connected to the second source electrode to provide the second source electrode with the second data signal.

12. The liquid crystal display apparatus of claim 10, wherein the array layer further comprises a second insulating layer to cover the second pixel electrode, the first and second source electrodes, and the first and second drain electrodes.

13. The liquid crystal display apparatus of claim 6, wherein the color filter substrate further comprises a black matrix on the second substrate corresponding to the first and second switching elements.

14. A liquid crystal display apparatus comprising:
a first array substrate having a first substrate and a first array layer on the first substrate,
the first array layer comprising:
a first switching element to receive a first data signal; and
a first pixel electrode to receive the first data signal, wherein the first pixel electrode is electrically connected to the first switching element,
a second array substrate having a second substrate facing the first substrate and a second array layer on the second substrate,
the second array layer comprising:
a second switching element to receive a second data signal having a polarity opposite to that of the first data signal; and
a second pixel electrode facing the first pixel electrode, wherein the second pixel electrode is electrically connected to the second switching element to receive the second data signal, and
a liquid crystal layer between the first and second substrates, the liquid crystal layer having liquid crystal molecules aligned in response to the first and second data signals applied to the first and second pixel electrodes, respectively.

15. The liquid crystal display apparatus of claim 14, wherein the first array layer further comprises a first gate line electrically connected to a first gate electrode of the first switching element to provide the first gate electrode with a first gate signal, and wherein the second array layer further comprises a second gate line electrically connected to a second gate electrode of the second switching element to provide the second gate electrode with a second gate signal.

16. The liquid crystal display apparatus of claim 15, wherein the first array layer further comprises a first data line electrically connected to a first source electrode of the first switching element to provide the first source electrode with the first data signal, and wherein the second array layer further comprises a second data line electrically connected to a second source electrode of the second switching element to provide the second source electrode with the second data signal.

17. The liquid crystal display apparatus of claim 14, wherein the first and second pixel electrodes comprise a transparent and conductive material, and wherein the first and second pixel electrodes are electrically connected to a first drain electrode of the first switching element and a second drain electrode of the second switching element, respectively.

18. The liquid crystal display apparatus of claim 14, wherein the first or the second array layer further comprises a color filter layer having a red color pixel, a green color pixel and a blue color pixel.

19. The liquid crystal display apparatus of claim 14, wherein the first array layer further comprises a first black matrix between the first substrate and the first switching element, and wherein the second array layer further comprises a second black matrix between the second substrate and the second switching element.

20. The liquid crystal display apparatus of claim 14, further comprising a backlight assembly disposed under the first array substrate to generate light.

21. The liquid crystal display apparatus of claim 20, wherein the backlight assembly comprises:
a first light source to generate a red light;
a second light source to generate a green light; and
a third light source to generate a blue light.

22. The liquid crystal display apparatus of claim 21, wherein the first, second and third light sources are sequentially turned on during a horizontal line period (1H).

23. The liquid crystal display apparatus of claim 14, wherein the first and second array layers are formed on the first and second array substrate, respectively, and wherein the first and second array layers are patterned using a mask that is the same mask for both array layers.
